(19) United States
(12) Patent Application Publication
(10) Pub. No.: US 2006/0173884 A1
(43) Pub. Date: Aug. 3, 2006

(54) Methods for merging files and related systems

(75) Inventors: Tsung-I Lin, Sanchung City (TW); Yu-Chuan Yang, Taipei City (TW); Chao-Lung Lee, Banchiau City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/089,062

(22) Filed: Mar. 24, 2005

Related U.S. Application Data
(60) Provisional application No. 60/648,568, filed on Jan. 31, 2005.

(51) Int. Cl. G06F 17/00; G06F 7/00

(52) U.S. Cl. 707/101

(57) ABSTRACT

Methods for merging files and related systems. A first file comprising a plurality of columns is provided. Each column comprises at least one data field for a row corresponding to a string identification. It is determined whether the string identification corresponding to the row is in a second file. If the string identification is in the second file, data for the row corresponding to the string identification in a first column of the second file is written to the row in the first column of the first file. If the string identification is not in the second file, data for the row in a second column of the first file is copied to the row in the first column of the first file.

### PARENT CASE TEXT

This U.S. patent application claims the benefit of U.S. Provisional Application 60/648,568, filed Jan. 31, 2005, entitled “Methods for Merging files and related systems”.

### BACKGROUND

The present disclosure relates generally to methods and systems for merging files.

To enjoy an international market, software program providers produce multi-language versions of their products, so that they can be used by people who speak different languages. A mobile phone manufacturer often provides MMIs (Man Machine Interface) in multi-language versions. During development, the interfaces are originally designed in one language, and will further be translated into different languages when the interface design is completed. For example, an interface originally created for an English speaking user may be translated into other languages before the program is shipped to other countries. For some purposes, such as localization, the programmers or clients will modify, add, or delete some strings in a file, such as a string table for use in interfaces.

The file is copied from a server, and such amendments are made to the copy. The amended parts are marked or highlighted in the updated copy. Conventionally, engineers manually review and compare the updated and original files, and incorporate the amendments to the original file. This process is tedious and time-consuming and requires manual review and incorporation of files.

### SUMMARY

Methods for merging files and related systems are provided. In an exemplary embodiment of a method for merging files, a first file comprising a plurality of columns is provided. Each column comprises at least one data field for a row corresponding to a string identification. It is determined whether the string identification corresponding to the row is in a second file. If yes, data for the row corresponding to the string identification in a first column of the second file is written to the row in the first column of the first file. If not, data for the row in a second column of the first file is copied to the row in the first column of the first file.

In an exemplary embodiment of a method for merging files, a first file comprising a plurality of columns is provided. Each column comprises first and second rows respectively corresponding to first and second string identifications. It is determined whether the first string identification corresponding to the first row is in a second file. If yes, data for the first row corresponding to the string identification in a first column of the second file is written to the first row in the first column of the first file. If not, data for the first row in a second column of the first file is copied to the first row in the first column of the first file. It is determined whether the second string identification corresponding for the second row is in the first and second files. If yes, it is determined whether data for the second row corresponding to the second string identification in the first column of the second file consists with data for the second row in the first column of the first file, and if not, the data for the second row in the first column of the first file is replaced with the data for the second row corresponding to the second string identification in the first column of the second file.

In an exemplary embodiment of a method for merging a second file to a first file, the first and the second file respectively have at least a data field corresponding to an identification. A data field is selected from the second file. It is determined whether the identification of the data field is found in the first file. If the identification is found in the first file, it is determined whether the data field of the identification in the first file consists with the data field in the second file. If it does not consist, the data field in the first file is replaced by the data field in the second file.

In an exemplary embodiment of a method for merging a second file to a first file, the first and the second file respectively have a plurality of data fields corresponding to at least one column and row. The column corresponds to a column number and the row corresponds to an identification. A data field is selected from the second file. It is determined whether the identification of the data field is found in the first file. It is determined whether the column number of the data field is found in the first file. It is determined whether the data field corresponding to both the column number and the identification in the first file consists with the data field in the second file. If it does not consist, the data field in the first file is replaced by the data field in the second file.

Methods for merging files and related systems may take the form of program code embodied in a tangible media. When the program code is loaded into and executed by a machine, the machine becomes an apparatus for practicing the disclosed method.

### DESCRIPTION OF THE DRAWINGS

Methods for merging files and related systems will become more fully understood by referring to the following detailed description with reference to the accompanying drawings, wherein:

FIG. 1 is a schematic diagram illustrating an embodiment of a system for merging files;

FIG. 2 shows an example of an embodiment of a file;

FIG. 2A is a diagram showing an embodiment of a merge file;

FIG. 2B is a diagram showing an embodiment of a merge file;

FIG. 3 is a flowchart showing an embodiment of a merge method by row;

FIG. 4 is a flowchart showing an embodiment of a merge method by column;

FIG. 5 is a flowchart showing an embodiment of a merge method; and

FIG. 6 is a diagram showing an embodiment of a merge file.

### DESCRIPTION

Methods for merging files and related systems are provided.

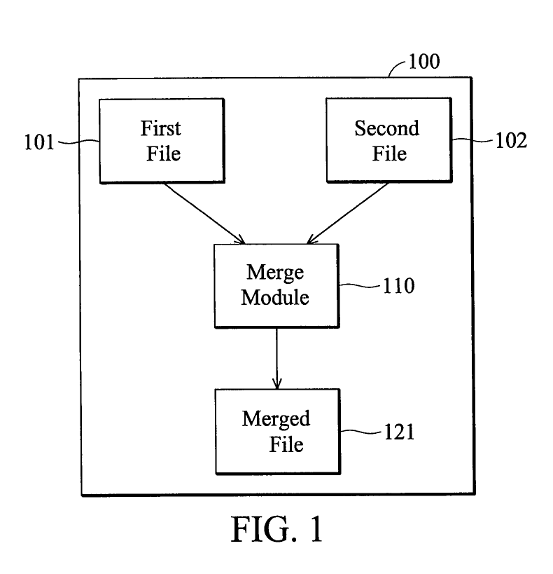

FIG. 1 is a schematic diagram illustrating an embodiment of a system for merging files. The system 100 may be a computer system practicing the merging methods of the application. The system 100 comprises a first file 101, a second file 102, and a merge module 110 that merges the first file 101 and the second file 102 into a merged file 121. The first file 101 may be a string table comprising a plurality of columns of data fields. Each column corresponds to at least one row having a unique string identification. In some embodiments, the files may be used in MMI (Man Machine Interface) applications of devices, such as mobile phones. In some embodiments, in the table of the file, the data for a row in different columns may be a string in different language versions.

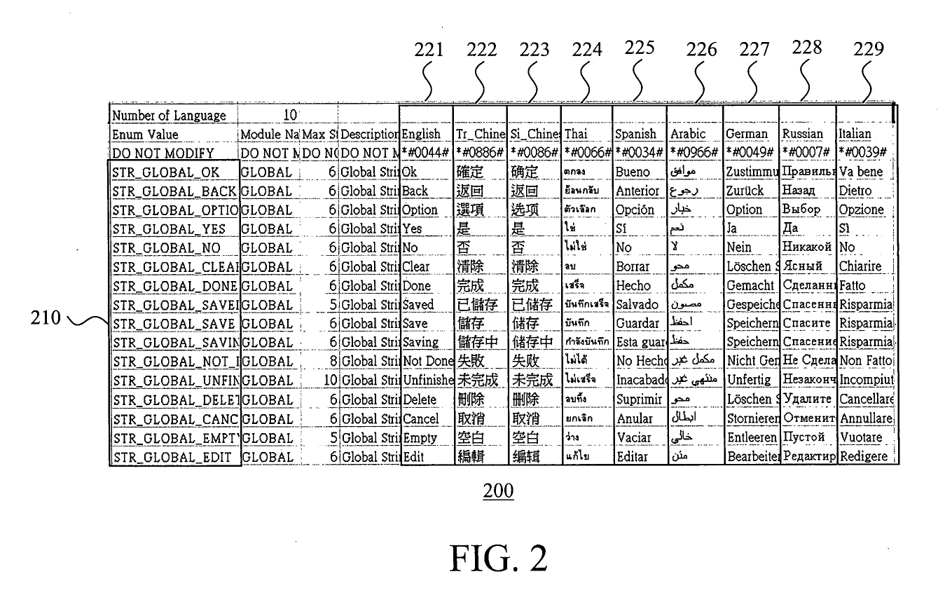

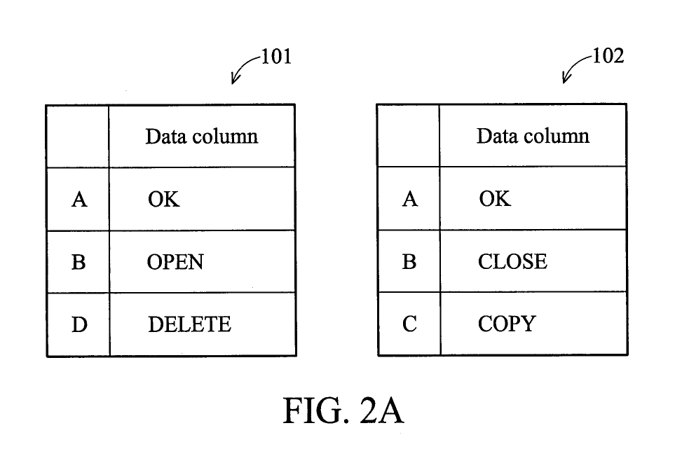

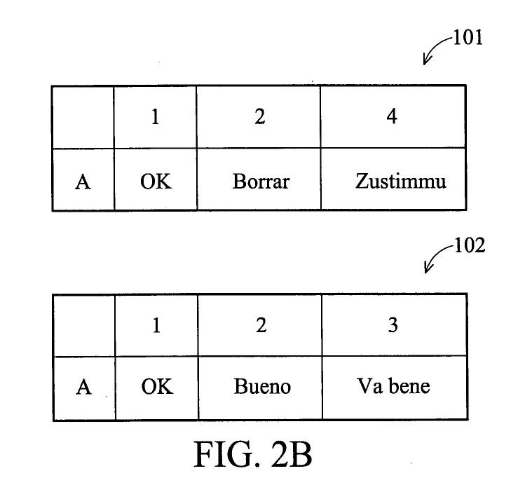

FIG. 2 shows an example of an embodiment of a file. File 200 comprises a plurality of columns 221, 222, . . . , and 229, each of them respectively corresponding to a plurality of rows. Each row has a string identification 210. In this example, as shown in FIG. 2, the data for a row of different columns is in fact the same string in different languages. For example, the data for the row corresponding to the string identification “STR_GLOBAL_OK” of the column “English” 221 is “OK”, and that of the column “Spanish” 225 is “Bueno”. However, it should be noted that the file content is not a limitation to this present invention. Any types of files presented in a table with columns and rows should be covered in the scope of this invention.

The second file 102 may be a duplicate or a modification of the first file 101. For example, instead of exactly copying the content of the first file, some new rows and/or columns may be added to the second file 102, and data in specific rows and columns of the second file 102 may be further modified. Additionally, the first file 101 can also be modified by users at any time. The merge module 110 incorporates the modified first file 101 and second file 102 to generate the merged file 121. Two merge methods, by row and by column are provided in the application.

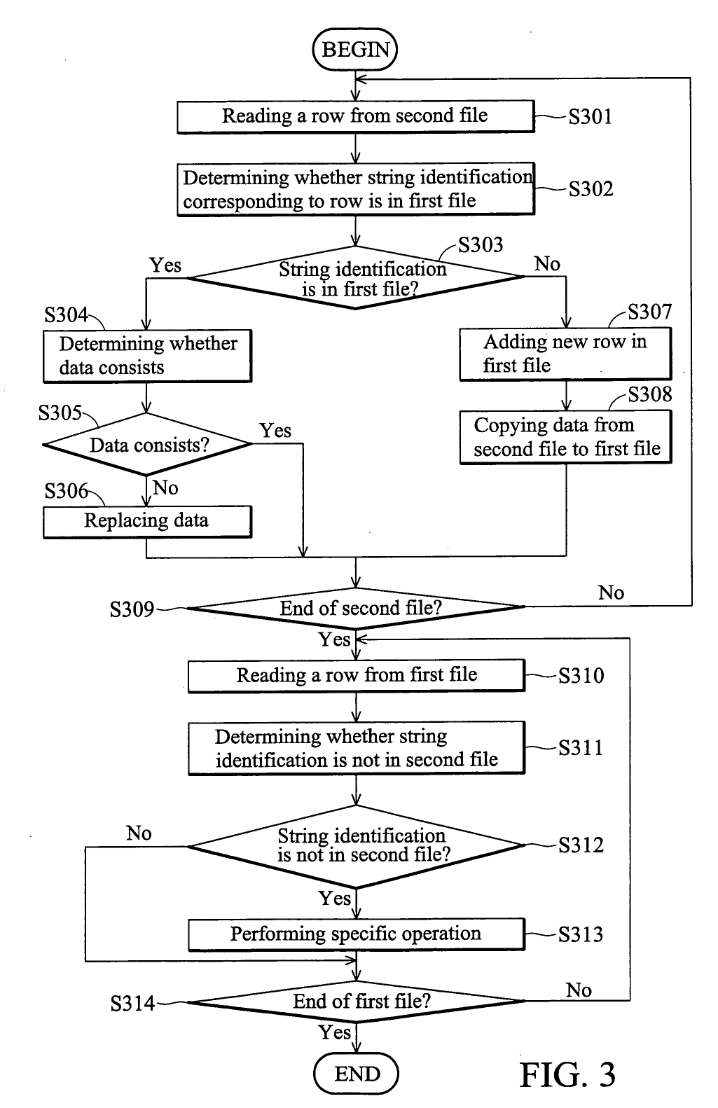

FIG. 2A is a diagram showing an embodiment of a merge file. FIG. 3 is a flowchart showing an embodiment of a merge method by row. As shown in FIG. 2A, the first file has rows A, B, and D and the second file has rows A, B, and C. Both rows A in the first and the second file contain a string “OK” in its data column. The row B in the first file contains a string “OPEN” whereas the row B in the second file contains a string “CLOSE” in its data column. The row C in the second file contains a string “COPY”. The row D in the first file contains a string “DELETE”. It is assumed that, in this embodiment, the second file is merged into the first file, and only one data column is discussed here.

In step S301, a row corresponding to a unique string identification is selected from the second file. In step S302, it is determined whether the first file also has a row corresponding to the string identification. If yes (Yes in step S303), in step S304, it is determined whether the string in the data column of the row in the second file consists with the string in the data column of the row of the first file. If yes (Yes in step S305), the procedure goes to step S309. In this embodiment, as shown in FIG. 2A, the first and the second file both have a row A and data string “OK” in its data column. Therefore, while the row A is selected, the method goes to step S309 for further operation.

However, if it does not consist (No in step S305), in step S306, the string in the data column of the row in the first file is replaced with the string in the data column of the row in the second file. For example, the string of the row B in the first file is “OPEN” whereas that of the row B in the second file is “CLOSE”. In this embodiment, to merge the second file into the first file, while the row B is selected, the string “OPEN” is replaced by “CLOSE”. However, it should be noted that where the file is merged into is predetermined according to user's need. That is, users can choose to merge the first file into the second file, or vice versa.

On the other hand, if the string identification is not found in the first file (No in step S303), in step S307, a new row with the string identification is added in the first file, and in step S308, the string of the row in the second file is copied to the data column of the new row in the first file. Here, as shown in FIG. 2A, unlike the second file, the first file doesn't have row C. Therefore, while the row C in the second file is selected and the string identification C could not be found in the first file, a new row with the string identification C and the string “COPY” is added to the first file.

In step S309, it is determined whether all rows in the second file have been selected. If not (No in step S309), the procedure returns to step S301. If yes (Yes in step S309), in step S310, a row is selected from the first file. In step S311, it is determined whether the string identification corresponding to the row is not found in the second file. If not (No in step S312), the procedure goes to step S314. If yes (Yes in step S312), in step S313, a specific operation is performed. In this embodiment, the row D exists only in the first file, not in the second file. While the row D in the first file is selected, a predetermined operation will be performed. In this invention, the specific operation can be predetermined according to user's demand. For example, it could be keeping the string of the row D in the first file or removing the whole row D and its string from the first file. In step S314, it is determined whether all of rows in the first file have been selected. If not (No in step S314), the procedure returns to step S310. If yes (Yes in step S314), the merge operation is completed.

It should be noted that, instead of merging files by rows, the present invention could also merge files by columns.

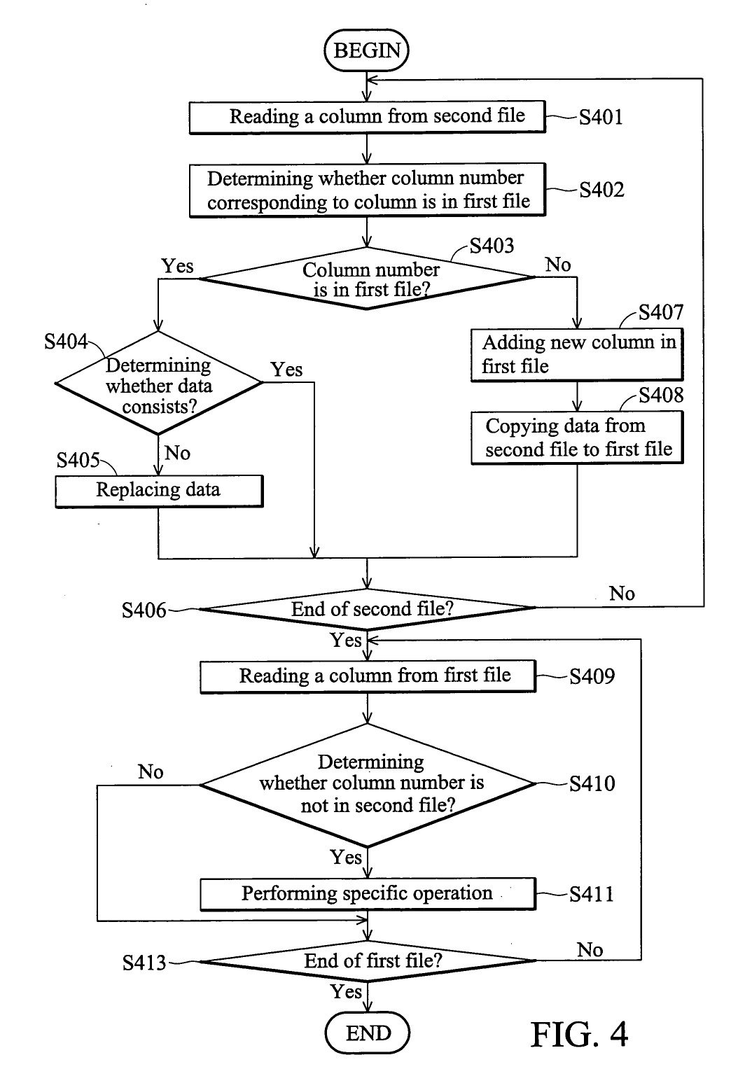

FIG. 2B is a diagram showing an embodiment of a merge file. FIG. 4 is a flowchart showing an embodiment of a merge method by column. As shown in FIG. 2B, the first file has columns 1, 2, and 4 and the second file has columns 1, 2, and 3. Both columns 1 in the first and the second file contain a string “OK” in its data row. The column 2 in the first file contains a string “Borrar” whereas the column 2 in the second file contains a string “Bueno” in its data row. The column 3 in the second file contains a string “Va bene”. The column 4 in the first file contains a string “Zustimmu”. It is assumed that, in this embodiment, the second file is merged into the first file, and only one data row is discussed here.

In step S401, a column corresponding to a unique column number is selected from the second file. In step S402, it is determined whether the column number is also found in the first file. If yes (Yes in step S403), in step S404, it is determined whether the string in the data row of the column in the first file consists with the string in the data row of the column in the second file. If yes (Yes in step S404), the procedure goes to step S406. In this embodiment, as shown in FIG. 2B, the first and the second file both have a column 1 and data string “OK” in its data row. Therefore, while the column 1 is selected, the method goes to step S406 for further operation.

However, if it does not consist (No in step S404), in step S405, the string in the data row of the column in the first file is replaced with the string in the data row of the column in the second file. For example, the string of the column 2 in the first file is “Borrar” whereas that of the column 2 in the second file is “Bueno”. In this embodiment, to merge the second file into the first file, while the column 2 is selected, the string “Borrar” is replaced by “Bueno”. However, it should be noted that where the file is merged into is predetermined according to user's need. That is, users can choose to merge the first file into the second file, or vice versa.

On the other hand, if the column number is not found in the first file (No in step S403), in step S407, a new column with the column number is added in the first file, and in step S408, the string of the column in the second file is copied to the data row of the new column in the first file. Here, as shown in FIG. 2B, unlike the second file, the first file doesn't have column 3. Therefore, while the column 3 in the second file is selected and the column number 3 is not found in the first file, a new column with the column number 3 and the string “Va bene” is added to the first file.

In step S406, it is determined whether all columns in the second file have been selected. If not (No in step S406), the procedure returns to step S401. If yes (Yes in step S406), in step S409, a column is selected from the first file. In step S410, it is determined whether the column number corresponding to the column is not found in the second file. If not (No in step S410), the procedure goes to step S412. If yes (Yes in step S410), in step S411, a specific operation is performed. In this embodiment, the column 4 exists only in the first file, not in the second file. While the column 4 in the first file is selected, a predetermined operation will be performed. In this invention, the specific operation can be predetermined according to user's demand. For example, it could be keeping the string of the column in the first file or removing the whole column and its string from the first file. In the step S412, it is determined whether all of columns in the first file have been selected. If not (No in step S412), the procedure returns to step S409. If yes (Yes in step S412), the merge operation is completed.

In some embodiment, the first and second file might be a data table having a plurality of rows and columns. Therefore, it should be noted that, to merge two table files, the invention might need to perform column merge operation and the row merge operation in proper order for merge efficiency.

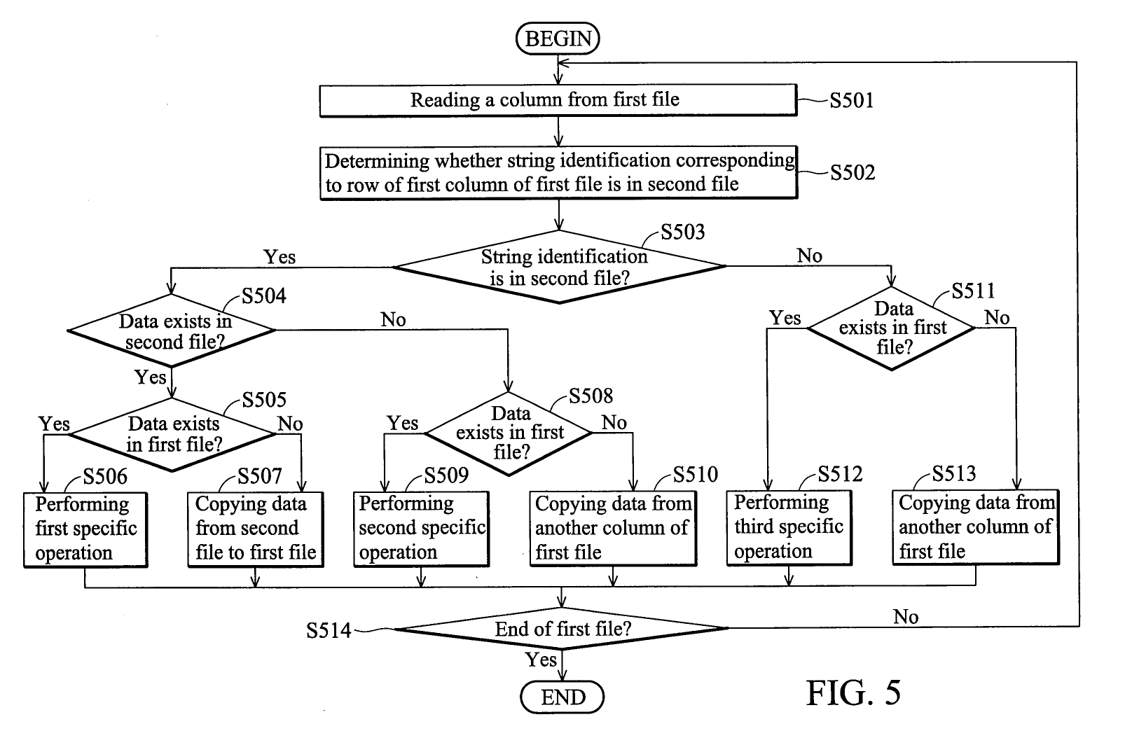

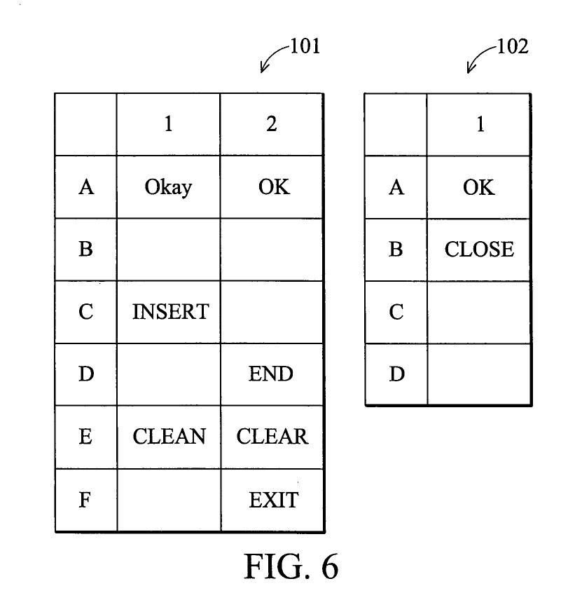

FIG. 6 is a diagram showing an embodiment of a merge file. As shown in FIG. 6, the first file 101 has columns 1 and 2, and the second file 102 has column 1. The first file 101 has data fields corresponding to row A, B, C, D, E, and F. Data for rowB, D, and E of column 1 in the first file 101 is “Okay”, “INSERT”, and “CLEAN”, respectively. No data exists for row B, D, and F of column 1 in the first file 101. Data for row A, D, E, and F of column 2 in the first file 101 is “OK”, “END”, “CLEAR”, and “EXIT”, respectively. No data exists for row B, and C of column 2 in the first file 101. The second file 102 has data fields corresponding to row A, B, C, and D. Data for row A, and B of column 1 in the second file 102 is “OK”, and “CLOSE”, respectively. No data exists for row C, and D of column 1 in the second file 102. FIG. 5 is a flowchart showing an embodiment of a merge method. It is understood that, in this embodiment, the second file is merged into the first file, and a row is designated.

In step S501, a first column is read from the first file 101. In step S502, it is determined whether the string identification corresponding to the designated row of the first column is in the second file 102. It is understood that, in step S502, it is also determined whether the first column is in the second file 102 according to the column number of the first column. If yes (Yes in step S503), in step S504, it is determined whether the data for the row in the first column of the second file 102 exists. If yes (Yes in step S504), in step S505, it is determined whether the data for the row in the first column of the first file 101 exists. If yes (Yes in step S505), in step S506, a first specific operation is performed. The first specific operation can be preset. The first specific operation may be replacing the data for the row in the first column of the first file 101 with the data for the row in the first column of the second file 102. In this embodiment, the column 1 exists in the first and second files, and row A exists in the first and second files. While column 1 and row A in the first file 101 are read and designated, a first specific operation is performed. In some embodiments, the string “Okay” in the first file 101 is replaced with the string “OK” in the second file 102.

If not (No in step S505), in step S507, the data for the row corresponding to the string identification in the first column of the second file 102 is written to the row in the first column of the first file 101. In this embodiment, while column 1 and row B in the first file 101 are read and designated, since no data exists for row B in the first file 101, the string “CLOSE” in the second file 102 is copied for row B in the first file 101.

If the data for the designated row in the first column of the second file 102 does not exist (No in step S504), in step S508, it is determined whether the data for the row in the first column of the first file 101 exists. If yes (Yes in step S508), in step S509, a second specific operation is performed. Similarly, the second specific operation can be preset. The second specific operation may be removing the data for the row in the first column of the first file 101, or keeping the original data for the row in the first column of the first file 101. In this embodiment, while column 1 and row C in the first file 101 are read and designated, since no data exists for row C in the second file 102, the string “INSERT” in the first file 101 is removed or kept.

If not (No in step S508), in step S510, data for the row in a second column of the first file 101 is copied to the row in the first column of the first file 101. In this embodiment, while column 1 and row D in the first file 101 are read and designated, since no data exists for row D in the first and second files, the string “END” for row D in column 2 of the first file 101 is copied for row D in column 1 of the first file 101. In some embodiments, the data for the second column may be in a natural language, such as English, used during interface development.

If the string identification corresponding to the designated row of the first column is not in the second file 102 (No in step S503), in step S511, it is determined whether the data for the row in the first column of the first file 101 exists. If yes (Yes in step S511), in step S512, a third specific operation is performed. Similarly, the third specific operation can be preset. The third specific operation may be removing the data for the row in the first column of the first file 101, keeping the original data for the row in the first column of the first file 101, or copying data from another column of the first file 101. In this embodiment, while column 1 and row E in the first file 101 are read and designated, since no row E is in the second file 102, the string “CLEAN” for row E in column 1 of the first file 101 can be removed to empty, kept, or replaced with the string “CLEAR” for row E of column 2 in the first file 101.

If not (No in step S511), in step S513, data for the designated row in a second column of the first file 101 is copied to the designated row in the first column of the first file 101. In this embodiment, while column 1 and row F in the first file 101 are read and designated, since no data exists for row F in the first file 101, and no row F in the second file 102, the string “EXIT” for row F in column 2 of the first file 101 is copied for row F in column 1 of the first file 101.

In step S514, it is determined whether all of the columns in the first file 101 have been read. If not (No in step S514), the procedure returns to step S401. If yes (Yes in step S514), the merge is complete.

It is understand that, to speed up the file merge process, in the present invention, according to the size of the file, users can choose to merge files either by rows, columns, or both rows and columns.

Methods for merging files and related systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer or a device comprising a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer or a device comprising a mobile phone, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for merging files, comprising:
providing a first file comprising a plurality of columns, each column comprising at least one data field in a row corresponding to a string identification;
determining whether the string identification corresponding to the row is in a second file;
if the string identification is in the second file, writing data in the row corresponding to the string identification in a first column of the second file to the row in the first column of the first file; and
if the string identification is not in the second file, copying data in the row in a second column of the first file to the row in the first column of the first file.

2. The method of claim 1 wherein if the string identification is not in the second file, the method further comprises:
determining whether data in the row in the first column of the first file exists; and
if yes, stopping copy of the data in the row in the second column of the first file to the row in the first column of the first file, and keeping the original data in the row in the first column of the first file.

3. The method of claim 1 wherein if the string identification is in the second file, the method further comprises:
determining whether the data in the row in the first column of the second file exists; and
if not, copying the data in the row in the second column of the first file to the row in the first column of the first file.

4. The method of claim 3 further comprising:
determining whether data in the row in the first column of the first file exists; and
if yes, stopping copy of the data in the row in the second column of the first file to the row in the first column of the first file, and keeping the original data in the row in the first column of the first file.

5. The method of claim 1 further comprising:
determining whether a second string identification corresponding to a second row is in the first and second files;
if the second string identification is in the first and second files, determining whether data in the second row corresponding to the second string identification in the first column of the second file consists with data in the second row in the first column of the first file; and
if not, replacing the data in the second row in the first column of the first file with the data in the second row corresponding to the second string identification in the first column of the second file.

6. The method of claim 5 further comprising:
if the second string identification corresponding to the second row is in the second file, but not in the first file, adding the second row comprising the second string identification in the first column of the first file.

7. The method of claim 6 wherein if the second string identification corresponding to the second row is in the second file, but not in the first file, the method further comprises:
copying the data in the second row in the first column of the second file to the second row in the first column of the first file.

8. The method of claim 1 further comprising:
determining whether a third string identification corresponding to a third row is in the first and second files; and
if the third string identification corresponding to the third row is in the first file, but not in the second file, removing the third row from the first file.

9. The method of claim 1 wherein the data in the first and second columns is a string in different language versions.

10. A system for merging files, comprising:
means for providing a first file comprising a plurality of columns, each column comprising at least on data field for a row corresponding to a unique string identification;
means for determining whether the string identification corresponding to the row exists in a second file;
means for writing data in the row corresponding to the string identification in a first column of the second file to the row in the first column of the first file if the string identification is in the second file; and
means for copying data in the row in a second column of the first file to the row in the first column of the first file if the string identification is not in the second file.

11. A machine-readable storage medium comprising a computer program, which, when executed, causes a device to perform a method for merging files, the method comprising:
providing a fist file comprising a plurality of columns, each column comprising at least one data field for a row corresponding to a unique string identification;
determining whether the string identification corresponding to the row exists in a second file;
if the string identification is in the second file, writing data in the row corresponding to the string identification in a first column of the second file to the row in the first column of the first file; and
if the string identification is not in the second file, copying data in the row in a second column of the first file to the row in the first column of the first file.

12. A method for merging files, comprising:
providing a first file comprising at least two columns of data fields, each column comprising a first row corresponding to a first string identification;
determining whether the first string identification corresponding to the first row is in a second file;
if the first string identification is in the second file, writing data in the first row corresponding to the string identification in a first column of the second file to the first row in the first column of the first file;
if the first string identification is not in the second file, copying data in the first row in a second column of the first file to the first row in the first column of the first file;
determining whether a second string identification corresponding to a second row is in the first and second files;
if the second string identification is in the first and second files, determining whether data in the second row corresponding to the second string identification in the first column of the second file consists with data in the second row in the first column of the first file; and
if not, replacing the data in the second row in the first column of the first file with the data in the second row corresponding to the second string identification in the first column of the second file.

13. A method for merging a second file to a first file, the first and the second file respectively having at least a data field corresponding to an identification, comprising:
selecting a data field from the second file;
determining whether the identification of the data field is found in the first file;
if the identification is found in the first file, determining whether the data field of the identification in the first file consists with the data field in the second file; and
if it does not consist, replacing the data field in the first file by the data field in the second file.

14. A method for merging a second file to a first file, the first and the second file respectively having a plurality of data fields corresponding to at least one column and row, the column corresponding to a column number and the row corresponding to an identification, comprising:
selecting a data field from the second file;
determining whether the identification of the data field is found in the first file;
determining whether the column number of the data field is found in the first file;
determining whether the data field corresponding to both the column number and the identification in the first file consists with the data field in the second file; and
if it does not consist, replacing the data field in the first file by the data field in the second file.
